(19) United States
(12) Patent Application Publication
(10) Pub. No.: US 2009/0248390 A1
(43) Pub. Date: Oct. 1, 2009

(54) TRACE DEBUGGING IN A HARDWARE EMULATION ENVIRONMENT

(76) Inventors: Eric Durand, La Ville du Bois (FR); Laurent Buchard, Les Ulis (FR)

Correspondence Address: KLARQUIST SPARKMAN, LLP, 121 S.W. SALMON STREET, SUITE 1600, PORTLAND, OR, 97204, US

(21) Appl. No.: 12/060,021

(22) Filed: Mar. 31, 2008

(51) Int. Cl. G06F 9/455

(52) U.S. Cl. 703/23

(57) ABSTRACT

A system and method in an emulation environment is disclosed that can trace the emulation environment during emulation. In one embodiment, when emulation procedures are called during emulation, a trace procedure can also be called in order to log information associated with the emulation procedure. In another embodiment, the information to be logged can include an identification of the emulation procedure and a time stamp of when the emulation procedure was called. In yet another embodiment, a trace script can be executed in order to collect user-specified variables and/or other system data that can be used to trace and debug the emulation environment. In still another embodiment, memory can be available on an emulator, such as on emulator boards within the emulation environment. The memory can store trace information associated with the emulator boards that can be downloaded to a server, such as, during emulation or after a power failure to obtain the state of the emulator boards. During emulation, an emulator board can continuously update state information in the memory of its respective board.

### FIELD

The present disclosure generally relates to hardware emulators, and more particularly to trace debugging in a hardware emulator.

### BACKGROUND

Today's sophisticated SoC (System on Chip) designs are rapidly evolving and nearly doubling in size with each generation. Indeed, complex designs have nearly exceeded 50 million gates. This complexity, combined with the use of devices in industrial and mission-critical products, has made complete design verification an essential element in the semiconductor development cycle. Ultimately, this means that every chip designer, system integrator, and application software developer must focus on design verification.

Hardware emulation provides an effective way to increase verification productivity, speed up time-to-market, and deliver greater confidence in the final SoC product. Even though individual intellectual property blocks may be exhaustively verified, previously undetected problems can appear when the blocks are integrated within a system. Comprehensive system-level verification, as provided by hardware emulation, tests many system properties, such as overall system functionality, IP subsystem integrity, specification errors, block-to-block interfaces, boundary cases, and asynchronous clock domain crossings. Although design reuse, intellectual property, and high-performance tools all help by shortening SoC design time, they do not diminish the system verification bottleneck, which can consume 60-70% of the design cycle. As a result, designers can implement a number of system verification strategies in a complementary methodology including software simulation, simulation acceleration, hardware emulation, and rapid prototyping. But, for system-level verification, hardware emulation remains a favorable choice due to superior performance, visibility, flexibility, and accuracy.

A short history of hardware emulation is useful for understanding the emulation environment. Initially, software programs would read a circuit design file and simulate the electrical performance of the circuit very slowly. To speed up the process, special computers were designed to run simulators as fast as possible. IBM's Yorktown “simulator” was the earliest (1982) successful example of this—it used multiple processors running in parallel to run the simulation. Each processor was programmed to mimic a logical operation of the circuit for each cycle and may be reprogrammed in subsequent cycles to mimic a different logical operation. This hardware ‘simulator’ was faster than the then current software simulators, but far slower than the end-product ICs. When Field Programmable Gate Arrays (FPGAs) became available in the mid-80's, circuit designers conceived of networking hundreds of FPGAs together in order to map their circuit design onto the FPGAs so that the FPGA network would mimic, or emulate, the entire circuit. In the early 90's the term “emulation” was used to distinguish reprogrammable hardware that took the form of the design under test (DUT) versus a general purpose computer (or work station) running a software simulation program.

Soon, variations appeared. Custom FPGAs were designed for hardware emulation that included on-chip memory (for DUT memory as well as for debugging), special routing for outputting internal signals, and for efficient networking between logic elements. Another variation used custom IC chips with networked single bit processors (so-called processor based emulation) that processed in parallel and usually assumed a different logic function every cycle.

Physically, a hardware emulator resembles a large server. Racks of large printed circuit boards are connected by backplanes in ways that most facilitate a particular network configuration. Typically, a workstation connects to the hardware emulator for control, input, and output. Before the emulator can emulate a DUT, the DUT design must be compiled. That is, the DUT's logic must be converted (synthesized) into code that can program the hardware emulator's logic elements (whether they are processors or FPGAs). Also, the DUT's interconnections must be synthesized into a suitable network that can be programmed into the hardware emulator. The compilation is highly emulator specific and can be time consuming.

Once compilation is complete, the design can be downloaded to an emulator for emulating the design. Emulation of the design can take a number of days. If the emulation crashes or is disrupted for any reason, it is desirable to determine what happened and when. Without such information, days spent previous to the crash could be wasted.

Thus, it is desirable to provide an emulation environment that can include tracing functionality to assist in debugging in case of error.

### SUMMARY

The present disclosure provides a system and method that can trace an emulation environment during emulation.

In one embodiment, when an emulation procedure is called during emulation, a trace procedure can also be called in order to log information associated with the emulation procedure.

In another embodiment, the information to be logged can include an identification of the emulation procedure and a time stamp of when the emulation procedure was called.

In yet another embodiment, a trace script can be executed in order to collect user-specified variables and/or other system data that can be used to trace and debug the emulation environment.

In still another embodiment, memory can be available on emulator boards within the emulation environment. The memory can store trace information associated with the emulator boards that can be downloaded to a server during emulation or after a power failure to obtain the state of the emulator boards. During emulation, an emulator board can continuously update state information in the memory.

The foregoing and other objects, features, and advantages will become more apparent from the following detailed description, which proceeds with reference to the accompanying figures.

### BRIEF DESCRIPTION OF THE DRAWINGS

FIG. 1 is a system diagram of an exemplary hardware emulation environment.

FIG. 2 is a more detailed exemplary system diagram showing a host computer coupled to the emulator through an intermediate platform maintenance board.

FIG. 3 is a three-dimensional physical view of an exemplary system in accordance with FIG. 1.

FIG. 4 is a high-level system diagram of an embodiment showing various servers connected through a messaging bus.

FIG. 5 is a flowchart of an embodiment showing a trace function that can be called in response to execution of an emulation procedure.

FIG. 6 is a diagrammatic example of implementing the flowchart of FIG. 5.

FIG. 7 is a flowchart of an embodiment showing one technique for obtaining trace information from emulation boards.

FIG. 8 is a diagram of an exemplary system that can be used to implement the flowchart of FIG. 7.

FIG. 9 is a flowchart of an embodiment for executing a script that can be used to obtain trace information in the emulation environment.

FIG. 10 is a more detailed flowchart of an embodiment for executing a script that can be used to obtain trace information in the emulation environment.

FIG. 11 is a diagrammatic example of one form of a system that can be used to implement the flowchart of FIG. 9.

### DETAILED DESCRIPTION

Disclosed below are representative embodiments of testing techniques and associated apparatus that should not be construed as limiting in any way. Instead, the present disclosure is directed toward all novel and nonobvious features and aspects of the various disclosed methods, apparatus, and equivalents thereof, alone and in various combinations and subcombinations with one another. The disclosed technology is not limited to any specific aspect or feature, or combination thereof, nor do the disclosed methods and apparatus require that any one or more specific advantages be present or problems be solved.

As used in this application and in the claims, the singular forms “a,” “an” and “the” include the plural forms unless the context clearly dictates otherwise. Additionally, the term “includes” means “comprises.” Moreover, unless the context dictates otherwise, the term “coupled” means electrically or electromagnetically connected or linked and includes both direct connections or direct links and indirect connections or indirect links through one or more intermediate elements.

Although the operations of some of the disclosed methods and apparatus are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures do not show the various ways in which the disclosed methods and apparatus can be used in conjunction with other methods and apparatus.

Any of the methods described herein can be performed (at least in part) using software comprising computer-executable instructions stored on one or more computer-readable media. Furthermore, any intermediate or final results of the disclosed methods can be stored on one or more computer-readable media. For example, a software tool can be used to determine and store one or more control signals used to control any of the disclosed apparatus. Any such software can be executed on a single computer or on a networked computer (for example, via the Internet, a wide-area network, a local-area network, a client-server network, or other such network). For clarity, only certain selected aspects of the software-based implementations are described. Other details that are well known in the art are omitted. For the same reason, computer hardware is not described in further detail. It should be understood that the disclosed technology is not limited to any specific computer language, program, or computer. For instance, a wide variety of commercially available computer languages, programs, and computers can be used.

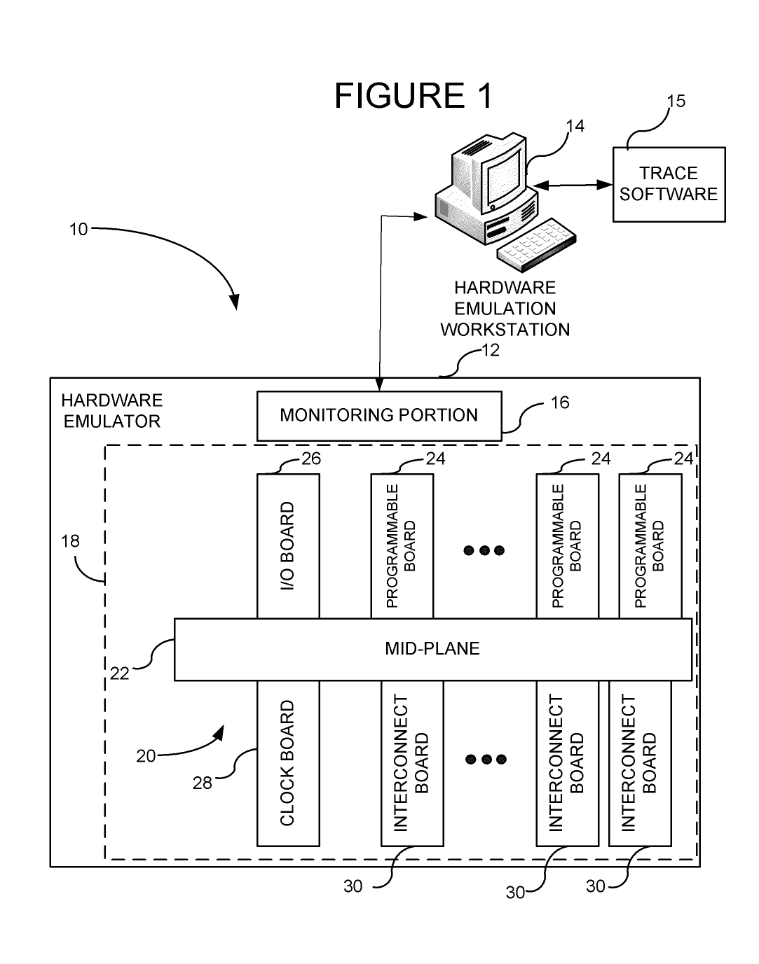

FIG. 1 shows an embodiment of an emulation environment 10 including a hardware emulator 12 coupled to one or more hardware emulator workstations (also called hosts) 14. The emulator host 14 can be any desired type of computer hardware and generally can include a user interface through which a user can load, compile and download a design to the emulator 12. As described further below, the host 14 can include one or more servers for communicating with the hardware emulator 12. Trace software 15 can be executed on the host 14. The trace software 15 can include a trace procedure that is executed upon every function call. Alternatively, or additionally, the trace software can include a script that executes an automated procedure to collect trace information. Other functions of the trace software 15 are further described below.

The emulator 12 can include a monitoring portion 16 and an emulation portion 18. The emulation portion 18 can include multiple printed circuit boards 20 coupled to a midplane 22. The midplane 22 can allow physical connection of the printed circuit boards into the emulator 12 on both sides of the midplane. A backplane can also be used in place of the midplane, the backplane allowing connection of printed circuit boards on one side of the backplane. Any desired type of printed circuit boards can be used. For example, programmable boards 24 generally can include an array of FPGAs, VLSIs or ICs, or other programmable circuitry, that can be programmed with the user's design downloaded from the emulator host 14. One or more I/O board interfaces 26 can allow communication between the emulator 12 and hardware external to the emulator. For example, the user can have a preexisting processor board that is used in conjunction with the emulator and such a processor board connects to the emulator through I/O board interface 26. A clock board 28 can be used to generate any number of desired clock signals. The interconnect boards 30 can allow integrated circuits on the programmable boards 24 to communicate together and with integrated circuits on the I/O board interface 26. Any combination of the above-mentioned boards may be used and any boards may be omitted. Additionally, it may be desirable in some applications to omit the midplane or backplane and use a different connection scheme.

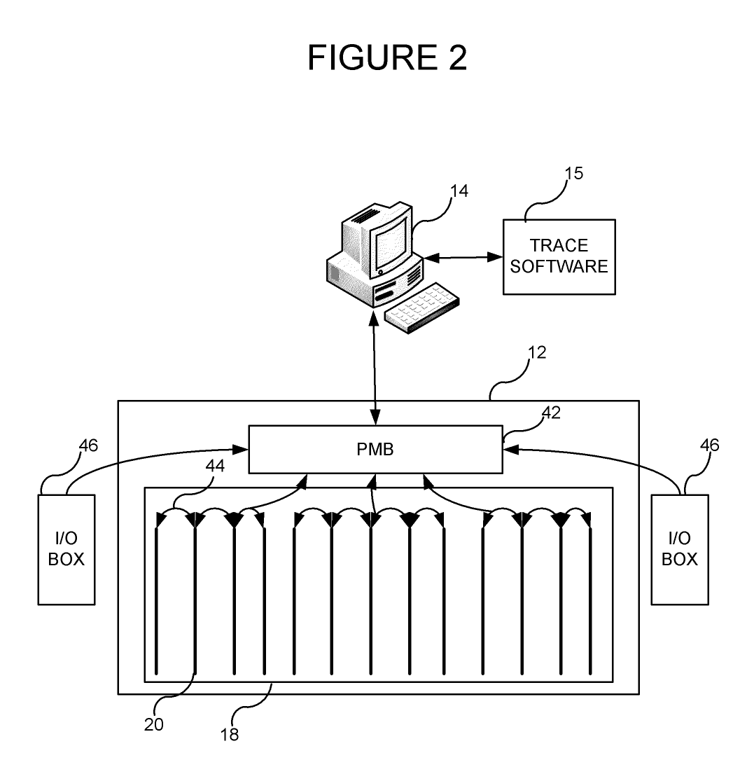

FIG. 2 shows a more detailed view of the exemplary system. A host computer 14 can be equipped with a high-speed-link PCI board coupled to a platform maintenance board (PMB) 42, which can act as the monitoring portion 16. The PMB 42 can monitor various physical parameters in the emulator portion 18 and can create the interface between the emulator portion 18 and the one or more host computers 14. The PMB 42 can, for example, on a periodic basis (e.g., 10 seconds), transmit communication and monitoring reports to the host workstation 14 for display in the GUI. Similarly, the PMB 42 can receive information regarding the physical parameters of the emulator portion 18, such as periodically. For example, hardware (e.g., an FPGA) on each printed circuit board 20 can have intelligence for monitoring physical parameters on its respective board and for sending this physical information to the PMB (e.g., every 5 seconds). Other changes, such as a detected error, can be transmitted immediately upon and in response to the detection. Thus, the PMB 42 can in one embodiment instantaneously (as opposed to periodically) detect any changes in the emulation environment 10 and can generate real-time state change messages to the host station 14. All of the physical parameters obtained through the PMB can be obtained while the emulator portion 18 is performing emulation. Thus, several emulations can be separately running and the physical parameters of the emulator can be separately viewed on the GUI of the host computers. However, there need not be a link between the number of simultaneous emulations and the number of workstations. For example, many emulations can be simultaneously run through one workstation. IO boxes 46 allow connection of other user boards to the system. The IO boxes 46 can also be coupled to the PMB 42 and monitored thereby. The PMB 42 can be used to obtain trace information stored in memory on the emulator boards, as further discussed below.

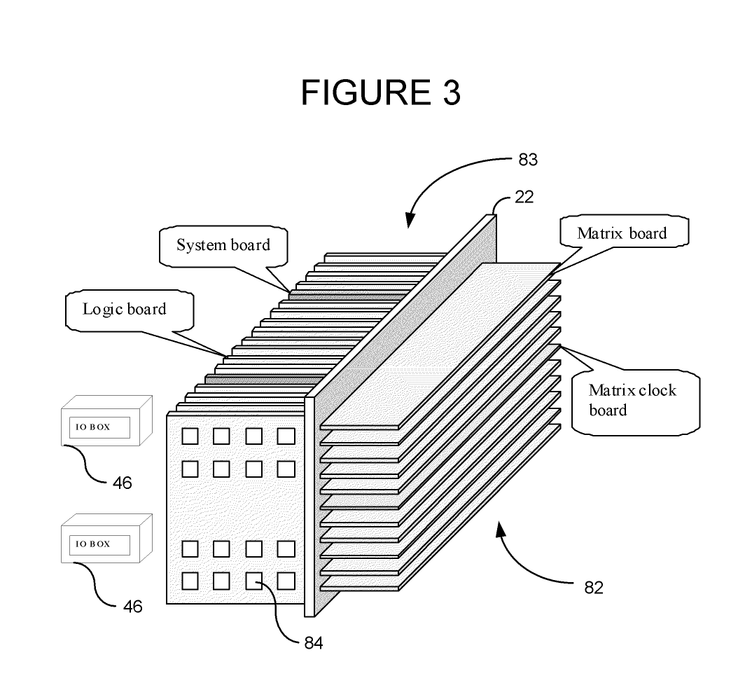

FIG. 3 shows an embodiment of a physical three-dimensional view of a single emulator chassis, which corresponds to the emulator portion 18, including the midplane 22 having horizontal boards 82 coupled to one side of the midplane, and vertical boards 83 coupled to the opposite side of the midplane. The physical integrated circuits are shown at 84. The IO boxes 46 can sit separately and are typically not generally considered part of the emulator.

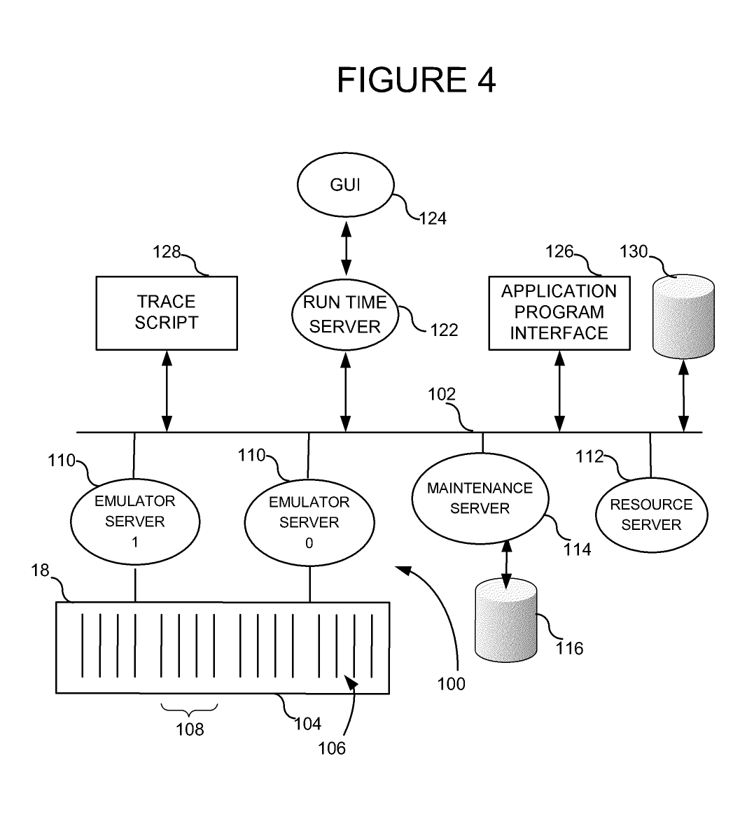

FIG. 4 shows a view of an embodiment of the emulator system including various servers (collectively indicated by number 100) that, in this embodiment, can communicate with one another, such as through a messaging bus 102. The emulator servers can be run on the workstation 14 (FIG. 1) (plural workstations can also be used). The emulator of FIG. 4 is a single chassis emulator, as shown at 104, but the emulator can include a plurality of chassis. Each chassis can include any number of printed circuit boards, shown generally at 106, but in the illustrated embodiment there are sixteen printed circuit boards. The printed circuit boards can be divided into partitions, such as the partition 108. A partition can be a set of one or more printed circuit boards, such as, for example, can be defined by the user, but in this embodiment a partition includes four printed circuit boards. By changing the size of the partitions, the user can change the granularity of the system. Emulator servers 110 can be in charge of managing a physical host connection to the emulator and can provide for the transfer of data between the emulator messaging bus 102 and the emulation portion 18. Thus, communication with the emulator boards 106 can be accomplished through the emulator servers. Any number of emulator servers 110 can be added. In one specific example there is one emulator server for each design being run in the emulator. A resource server 112 can be in charge of managing the different emulator resources provided to the applications. A maintenance server 114 can communicate with a database 116 that stores files associated with testing the emulator boards 106. A run-time server 122 can receive instructions through a GUI 124 and can interact with the emulator servers 110 either directly or indirectly to receive data from the emulator servers and provide control information to the emulator servers. An Application Program Interface (API) 126 and a trace script 128 can also be coupled to the messaging bus 102. As further described below, calls to procedures made by any of the servers 100 or emulator boards 106 can result in a call to the API 126. The API 126 can be a part of the trace software 15 (FIG. 1) and can log trace information, such as the name of any procedures that were called with an associated time stamp. The trace script 128 can also be part of the trace software 15 and can be called through the GUI 124. The trace script 128 can collect all desired trace information and store the same in an archive 130 coupled to the messaging bus 102. For example, the trace script 128 can gather trace information from the various servers 100. Additionally, the trace script can try to establish communications with one or more workstations 14 and, if successful, obtain desired log parameters from those workstations.

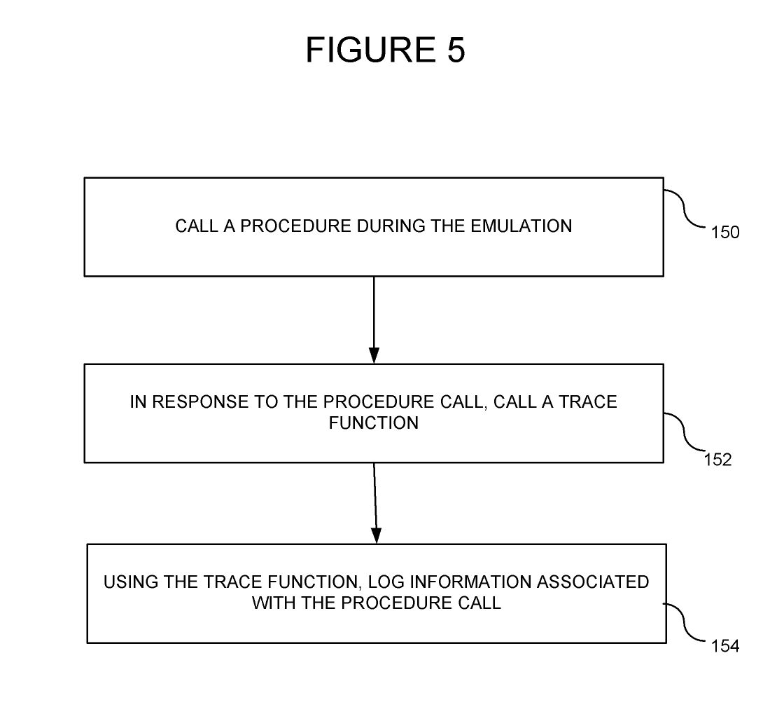

FIG. 5 is a flowchart of an embodiment showing one example of how API 126 can be used to capture trace information. In process block 150, any program running in the emulation environment 10 can make a procedure call. For example, any of the servers 100 can be running programs or program threads that make a call to a procedure. In process block 152, in response to the procedure call, a trace function (e.g., the API) can be called, desirably, automatically. By saying that the trace function is called “automatically”, it does not preclude a user step beforehand, such as to turn on the trace function. The API can then be used to store information about the procedure call, such as an identification of the procedure call and/or a time stamp when the call occurred (process block 154). Alternatively, other trace information about the procedure call can be stored instead of, or in addition to, the identification of the procedure call and the time stamp.

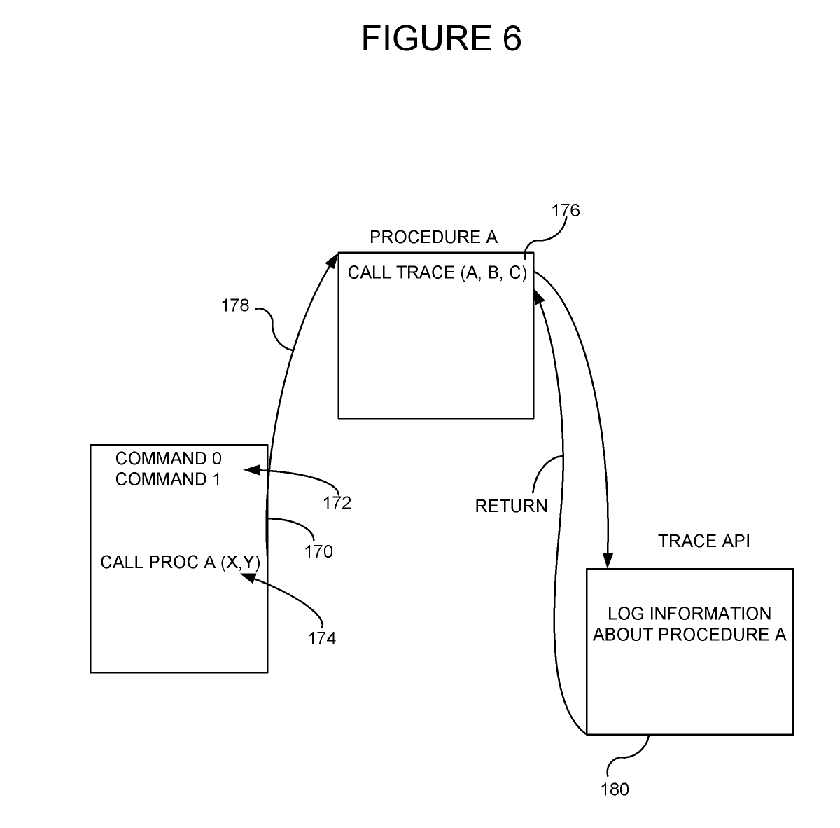

FIG. 6 is a diagram showing how an automated call can be made to the trace API. A procedure 170, which can be executing on any of the servers 100 or other devices in the emulation environment 10, can have a sequence of commands or programming statements, shown generally at 172. The programming statements can be any of a variety of statements, such as those in a programming language (e.g., C++). A programming statement 174 can be a call to procedure “A” (176), which causes a switching of control to procedure A, as shown by arrow 178. Procedure A can include, in turn, a call to the trace API 180. The trace API 180 can log the desired information and then can return control to procedure A. The trace API can perform any desired logging function. Parameters of the call are shown as A, B, and C, and can be used to assist in the logging of information. Such parameters can be logged directly or can be pointers to information to log. The name of Procedure A can be obtained through the parameters associated with the API call, or can be obtained through the return address and a look-up table. The trace API can be platform independent.

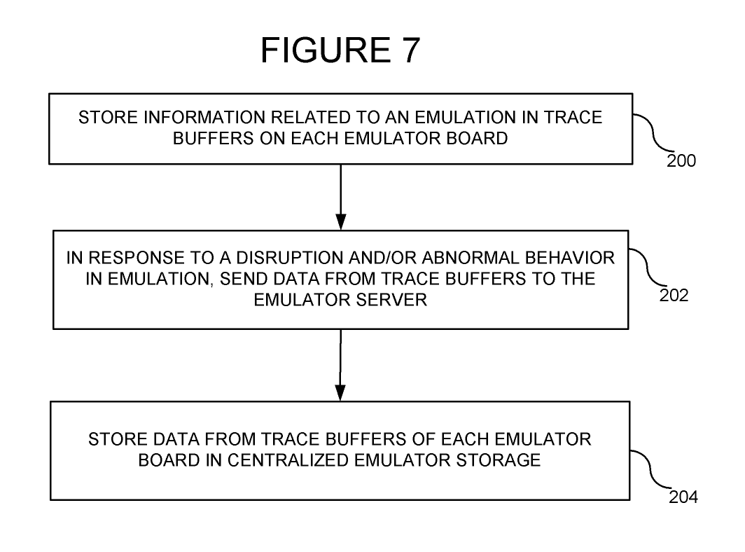

FIG. 7 shows a flowchart of an embodiment wherein trace information can also be obtained from emulation boards 106 (FIG. 4). In process block 200, each emulation board can have memory (e.g., volatile or non-volatile memory, such as flash memory) that stores trace information while an emulation is in progress. In process block 202, whenever there is a disruption, abnormal behavior, and/or a specific user request, the trace information can be sent from memory on the emulator boards to an emulator server 110. Such trace information can be sent through the PMB 42. In process block 204, the emulator server can pass the trace information together with a time stamp associated with the trace information to another server (e.g., maintenance server) or to the archive 130 for centralized storage.

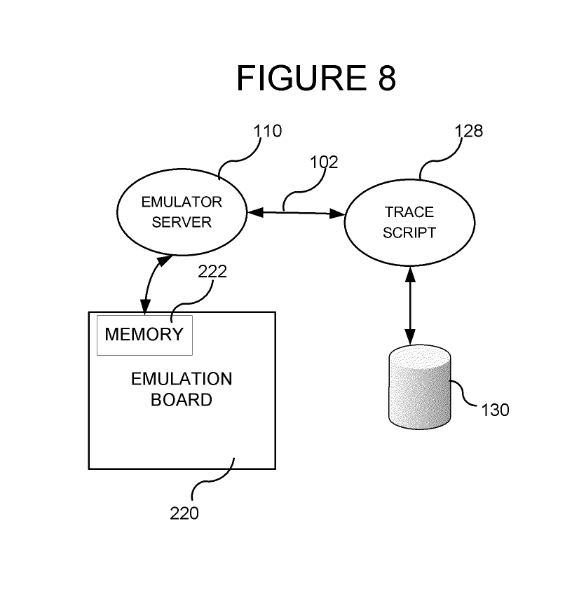

FIG. 8 shows an embodiment of the emulation environment wherein an emulation board 220 can include a memory 222, which is preferably flash memory or other type of non-volatile memory (volatile memories can also be used in certain embodiments). An emulator server 110 can be coupled to the trace script 128, such as through messaging bus 102. The script 128 can ensure that the trace information stored in the memory is saved to central storage 130. In the event of a loss of power, the trace information stored in the memory 222 can be delivered to the server 110, such as automatically, once power resumes, in order to have a better understanding of the system at the time that power was lost.

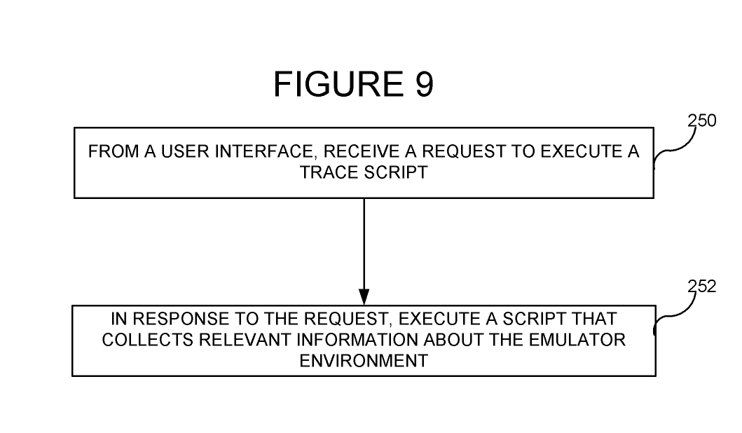

FIG. 9 is a flowchart of an embodiment wherein a user can request the emulator to execute a debugging collection procedure. In process block 250, a request is received to execute a trace script. Such a request can be made through the GUI 124 by the user. In response to the request, the trace script 128 can execute a variety of instructions, as defined by the user, so as collect information from the emulation environment, such as the state of servers, variables, emulator boards, emulation, etc. (process block 252). Instead of through a user interface, the trace script can be initiated automatically, such as through detection of an event (that a certain point is reached in emulation, a certain error occurred, etc.)

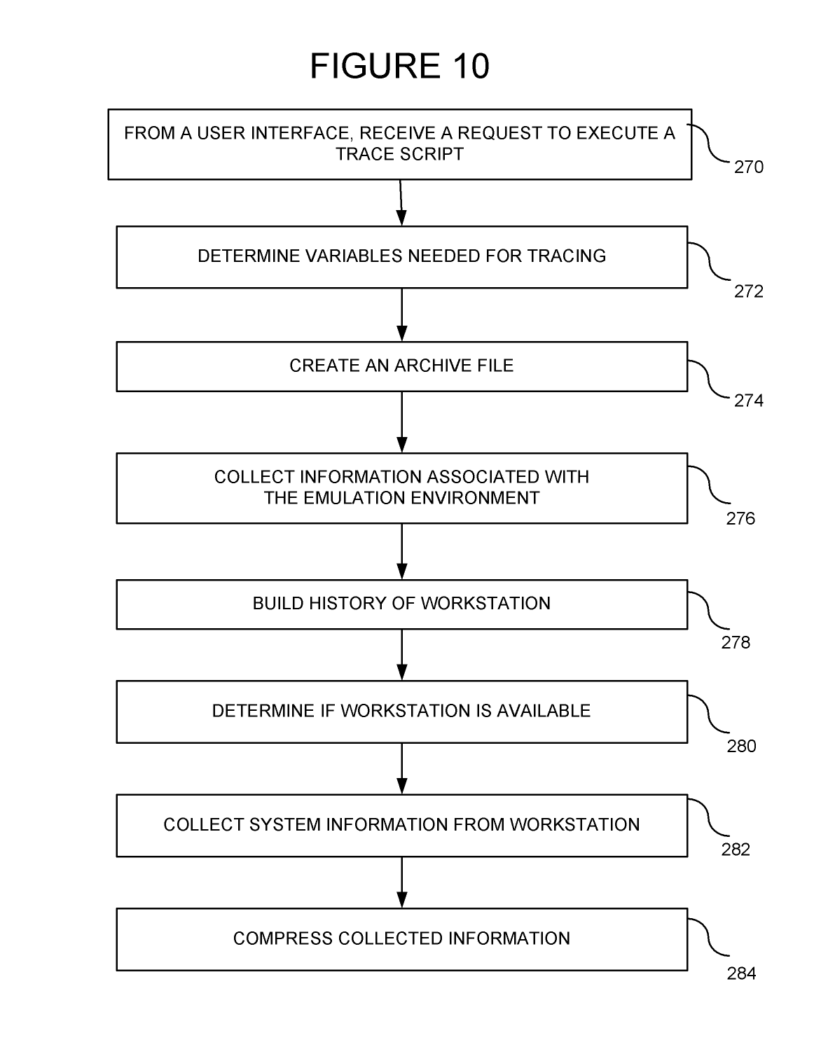

FIG. 10 is a flowchart of an embodiment showing particular examples of information that can be collected by the script 128 functioning as a data collection procedure. In process block 270, the user can request that the trace script be executed, such as by selecting an appropriate icon. In process block 272, the variables needed for tracing can be determined. For example, the user can setup a list of variables or other items to be collected when the script is executed. In process block 274, an archive file can be created. Alternatively, a preexisting archive file can be used. In process block 276, information associated with the emulation environment can be collected and temporarily stored in memory of the host 14. For example, variables identified in process block 272 can be obtained by determining their location and issuing a request or by reading the variables directly, if possible. Other information can be obtained, such as status information indicating the state of various servers in the system. In process block 278, a history of the workstation can be built. For example, any data related to the workstation, but not located on the workstation itself, can be collected and temporarily stored in memory of the host 14. In process block 280, a determination can be made whether the workstation is online through detection of the workstation. Such a determination can be made by soliciting the workstation for a response. If a response is received, then the workstation is available. In such a case, in process block 282, system information can be collected from the workstation. For example, a remote shell can be created for the workstation in order to collect the desired system information. In process block 284, the collected data can optionally be compressed and stored in the archive file.

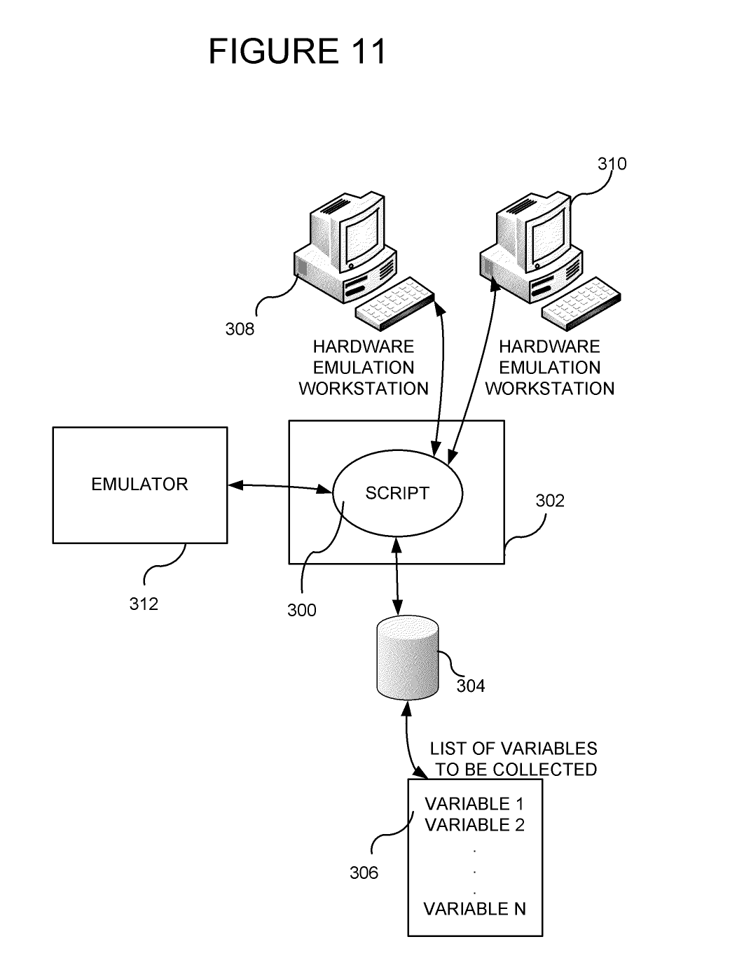

FIG. 11 is a diagram of an embodiment showing a script 300 that can be used as a collection procedure. The script 300 can be executed on a workstation 302. An archive 304 can store a list of variables 306 to be collected. Such a list can be, for example, established by and modified by the user. In this embodiment, plural other workstations 308, 310 can be coupled to workstation 302. The workstations 302, 308, 310 can be connected to an emulator 312 to form the emulation environment. As described in relation to FIG. 10, the script 300 can ping the other workstations 308, 310 by soliciting a response. Additionally, the script 300 can read the list of variables 306 and can obtain the variables that are available on the workstation 302, in the emulator 312 or on the other workstations, such as 308, 310.

Having described and illustrated the principles of illustrated embodiments, it will be recognized that the embodiments can be modified in arrangement and detail without departing from such principles.

In view of the many possible embodiments to which the principles of the disclosed invention may be applied, it should be recognized that the illustrated embodiments are only examples of the invention and should not be taken as limiting the scope of the invention. Rather, the scope of the invention is defined by the following claims. We therefore claim as our invention all that comes within the scope of these claims.

We claim:

1. A method of capturing trace information in an emulator, comprising:
during emulation, calling an emulation procedure;
automatically, in response to the call to the emulation procedure, calling a trace procedure; and
using the trace procedure, logging information associated with the emulation procedure.

2. The method of claim 1, wherein the information includes an identification of the emulation procedure.

3. The method of claim 2, wherein the information further includes a time stamp of when the emulation procedure was called.

4. The method of claim 1, wherein the logging information is automatically archived in a central storage of the emulator.

5. The method of claim 1, further including executing a trace script.

6. The method of claim 5, further including automatically running the script in response to the request, wherein the script includes reading a list of variables to be collected and stored.

7. The method of claim 6, further including detecting whether a workstation is online and, if the workstation is online, logging information associated with the detection that the workstation is online.

8. The method of claim 5, further including collecting information associated with status of servers executing on a workstation coupled to the emulator.

9. The method of claim 5, further including building a history of a workstation coupled to the emulator.

10. An emulation environment, comprising:
plural hardware emulation workstations;
a hardware emulator coupled to the plural hardware emulation workstations;
an application program interface to be executed on one of the plural workstations and that, when executed, stores trace information regarding time and identification information of procedure calls that occurred in the emulation environment; and
a database coupled to the hardware emulator for storing the trace information collected by the application program interface.

11. The emulation environment of claim 10, further including a script for reading the database to obtain a list of variables to be collected and stored with the trace information.

12. The emulation environment of claim 10, wherein the hardware emulator includes plural emulation boards, and further including a trace buffer stored on at least one of the emulation boards.

13. The emulation environment of claim 12, further including an emulation server coupled to the plural emulation boards for retrieving data stored in the trace buffer.

14. A method of capturing trace information in an emulation environment, comprising:
in response to a user request to collect trace information, reading a list of variables names;
for each variable name, locating an associated variable in the emulation environment; and
storing the associated variable in an archive of trace information.

15. The method of claim 14, further including determining whether an emulation workstation is online, and, if so, collecting additional trace information from the emulation workstation.

16. The method of claim 14, further including collecting additional trace information stored in memory on at least one emulator board in the emulation environment.

17. The method of claim 14, further including obtaining status information from different servers running in the emulation environment and including the status information in the archive of trace information.

18. An emulation environment, comprising:
means for calling an emulation procedure;
means for calling a trace procedure automatically, in response to the call to the emulation procedure; and
means for logging information associated with the emulation procedure.

19. A computer-readable medium having instructions thereon for executing a method comprising:
during emulation, calling an emulation procedure;
automatically, in response to the call to the emulation procedure, calling a trace procedure; and
using the trace procedure, logging information associated with the emulation procedure.
